(19) United States
(12) Patent Application Publication
(10) Pub. No.: US 2017/0097725 A1
(43) Pub. Date: Apr. 6, 2017

(54) DEVICE AND METHOD FOR STARTING MOBILE TERMINAL APPLICATION AND MOBILE TERMINAL

(71) Applicant: HISENSE MOBILE COMMUNICATIONS TECHNOLOGY CO., LTD., Qingdao (CN)

(72) Inventor: Yongqing WANG, Qingdao (CN)

(21) Appl. No.: 15/379,653

(22) Filed: Dec. 15, 2016

(30) Foreign Application Priority Data
Apr. 21, 2016 (CN) 201610251112.3

(51) Int. Cl. G06F 3/041

(52) U.S. Cl. CPC G06F 3/0416; G06F 3/0412; G06F 2203/04108

(57) ABSTRACT

The present disclosure relates to a device and method for starting a mobile terminal application and a mobile terminal to provide a solution for optimization of the speed of starting APPs installed on a mobile terminal. The method comprises: detecting a floating touch event for an application through a touch screen; loading resources of the application saved in a storage into a memory upon detection of the floating touch event for the application; starting the application based on the resources of the application loaded into the memory when a click event for the application is detected through the touch screen; otherwise, releasing the resources of the application in the memory.

### CROSS-REFERENCE TO RELATED APPLICATION

This application claims the benefit and priority of Chinese Patent Application No. 201610251112.3 filed Apr. 21, 2016. The entire disclosure of the above application is incorporated herein by reference.

### FIELD

The present disclosure relates to the technical field of communications, in particular to a device and method for starting mobile terminal application and a mobile terminal.

### BACKGROUND

This section provides background information related to the present disclosure which is not necessarily prior art.

With the rapid development of Internet and electronic technologies, mobile terminals have exhibited increasingly strong functions. Take mobile phones as an example, a growing number of applications (abbreviated as APP) are installed on smart mobile phones.

In the meantime, users have more and more requirements while experiencing applications on a mobile terminal, as a result of which it will be an important goal for various major mobile terminal developers during research and development to improve users' experience in using mobile terminals.

At present, an increasingly growing amount of memory is consumed by those developed APPs, in order to meet the users' demands. The performances of hardware equipment in mobile terminals are improved ceaselessly, but the speed at which the number of APPs and the memory consumed by APPs increase is much higher than that at which hardware equipment is improved in performance, which accordingly causes tremendous pressure in terms of the user's experience in using mobile terminals.

The speed of starting APPs installed on a mobile terminal, among other things, is a kind of extremely important user experience.

### SUMMARY

This section provides a general summary of the disclosure, and is not a comprehensive disclosure of its full scope or all of its features.

Provided in the embodiments of this disclosure are a device and method for starting a mobile terminal application and a mobile terminal, which are aimed at providing a solution for optimization of the speed of starting APPs installed on a mobile terminal.

The technical solution provided in the embodiments of this disclosure is as follows:

In a first aspect, provided in some embodiments of this disclosure is a device for starting an application, which includes:

a detecting module configured to detect a floating touch event for an application through a touch screen;

a loading module configured to load resources of the application saved in a storage into a memory upon detection of the floating touch event by the detecting module; and

a processing module configured to start the application based on the resources of the application loaded into the memory when a click event for the application is detected through the touch screen; otherwise, releasing the resources of the application in the memory.

In a second aspect, provided in some embodiments of this disclosure is a device for starting an application, which includes: a storage and one or more processors, where, the storage stores one or more computer-readable program codes, and the one or more processors are used for executing the one or more computer-readable program codes to:

detect a floating touch event for an application through a touch screen;

load resources of the application saved in the storage into a memory upon detection of the floating touch event by the detecting module; and

start the application based on the resources of the application loaded into the memory when a click event for the application is detected by the detecting module; otherwise, releasing the resources of the application in the memory.

In a third aspect, provided in the embodiments of this disclosure is method for starting a mobile terminal application, which includes:

detecting a floating touch event for an application through a touch screen;

loading resources of the application saved in a storage into a memory upon detection of the floating touch event for the application; and

starting the application based on the resources of the application loaded into the memory when a click event for the application is detected through the touch screen; otherwise, releasing the resources of the application in the memory.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating an application starting process in some embodiments of this disclosure;

FIG. 2 is a schematic diagram illustrating the distance between a finger and a touch screen in some embodiments of this disclosure;

FIG. 3 is a flow diagram illustrating the starting of an application by a mobile terminal in some embodiments of this disclosure;

FIG. 4 is a schematic diagram of a structure of a device for starting an application in some embodiments of this disclosure;

FIG. 5 is a schematic diagram of a structure of another device for starting an application in some embodiments of this disclosure; and

FIG. 6 is a schematic diagram of a structure of a mobile terminal in some embodiments of this disclosure.

Corresponding reference numerals indicate corresponding parts or features throughout the several views of the drawings.

### DETAILED DESCRIPTION

Example embodiments will now be described more fully with reference to the accompanying drawings.

Touch screens having a floating touch function have been currently available on the market. The so-called floating touch means that with a finger not in contact with a screen, it is possible to achieve an effect similar to the movement of a mouse onto a particular icon when the distance between the finger and the screen is smaller than a preset value. For instance, the preset value is 15 millimeters (mm).

It is a trend of development in the future to use the touch screens having the floating touch function. And so far, mobile terminals installed with a touch screen having the floating touch function have sprung up.

Based on the mobile terminals installed with a touch screen having the floating touch function, the embodiments of this disclosure provide a method for starting an application, with an aim of increasing the speed of starting applications and improving user experience.

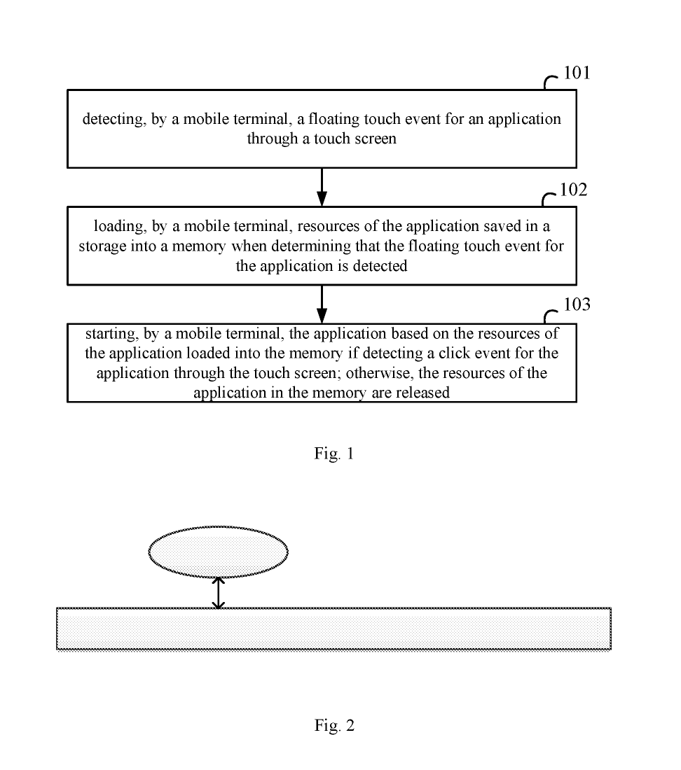

In some embodiments of this disclosure, in the mobile terminals installed with a touch screen having the floating touch function, the process of starting an application is shown in FIG. 1 and is as follows:

S101: detecting, by a mobile terminal a floating touch event for an application through a touch screen.

Optionally, the process for a mobile terminal to detect a floating touch event for an application is that: acquiring, by the mobile terminal, a distance, detected by the touch screen, between a finger pointing at the application and the touch screen, and determining the detection of the floating touch event for the application when it is determined that the detected distance is smaller than a first preset value.

Where, it may be appreciated that: determining the targeted application is that a relative position relationship between the finger and the touch screen is detected and the application at which the finger is directed can be obtained depending on the relative position relationship between the finger and the touch screen as well as a relative position relationship of the application in a display interface of the touch screen, and this application is determined as the targeted application.

Where, the first preset value is a boundary value for identifying whether the floating touch event is valid or not.

By way of example, FIG. 2 is a schematic diagram illustrating the distance between a finger and a touch screen, in which the oval stands for the finger and the rectangle stands for the side view of a mobile phone. When such a condition is met that a finger does not come into contact with the touch screen but the distance between the finger and the touch screen is smaller than the first preset value, then the function of starting resources required for application preloading and starting according to the floating touch event is started.

Optionally, the floating touch event for an application is a floating touch operation for an icon of the application.

S102: loading, by the mobile terminal, resources of the application saved in a storage into a memory when determining that the floating touch event for the application is detected.

Where, the resources of the application loaded into the memory are those required for starting and running the application. Optionally, the resources of the application loaded into the application include, but not limited to: one or more of the group consisting of picture resources, library files, database resources and the like. The resources required for starting and running each application differ during the implementation process.

S103: starting, by the mobile terminal, the application based on the resources of the application loaded into the memory if detecting a click event for the application through the touch screen; otherwise, releasing the resources of the application in the memory. A click event indicates that a finger gets in touch with the screen.

In some implementations, the mobile terminal releases the resources of the application in the memory if the click event for the application is not detected through the touch screen within a first preset period of time.

In some implementations, the mobile terminal detects the distance between the finger pointing at the application and the touch screen through the touch screen at intervals of a second preset period of time, and releases the resources of the application in the memory when it is determined that the detected distance is larger than a second preset value.

Where, the second preset value is a boundary value for identifying whether the floating touch event becomes invalid or not. During the implementation process, the first preset value and the second preset value may be the same as or different from each other. Alternatively, the first preset value is smaller than the second preset value if the first preset value and the second preset value are different.

Where, the first preset period of time is larger than the second preset period of time.

It should be noted that in the embodiments of this disclosure, the mobile terminal, after determining that the floating touch event for the application is detected, loads the resources corresponding to the application into a memory, without starting the application. The application is not started and run until the mobile terminal determines that the click event for the application is detected.

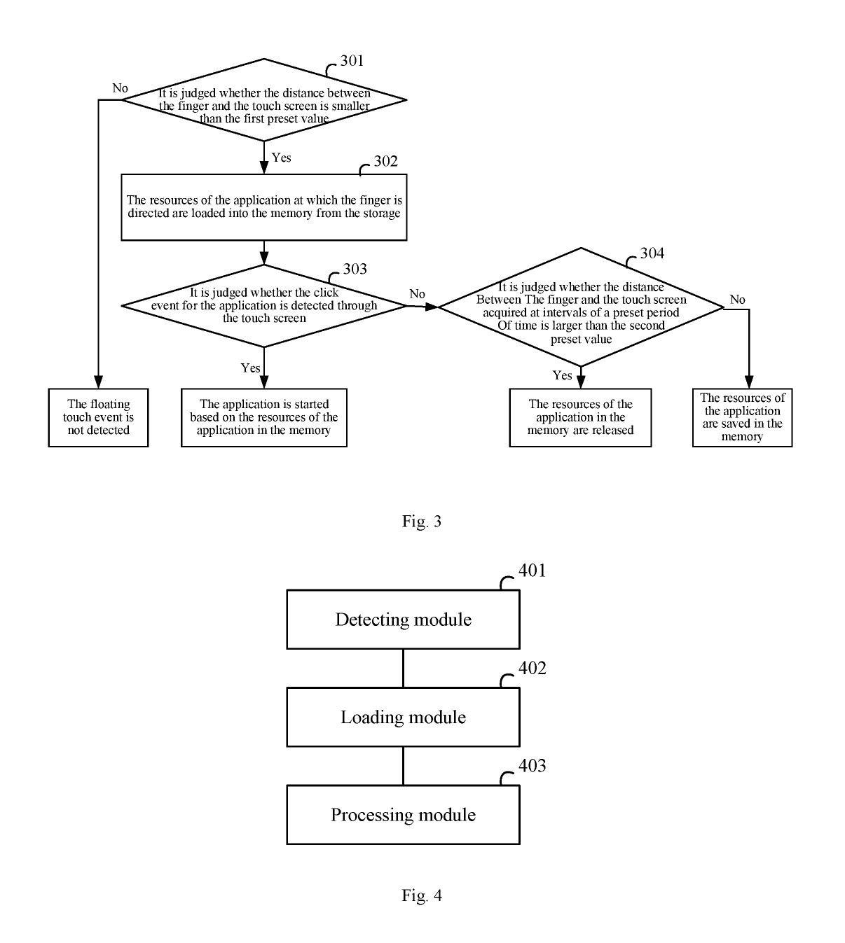

FIG. 3 is a flow diagram illustrating the starting of an application by a mobile terminal in some embodiments, which is as follows:

S301: acquiring, by the mobile terminal the distance between the finger and the touch screen through the touch screen, judging whether the distance is smaller than the first preset value, and determining that the floating touch event is not detected if the distance is not smaller than the first preset value; and executing S302 if the distance is smaller than the first preset value.

S302: loading, by the mobile terminal, the resources of the application at which the finger is directed, into the memory from the storage.

S303: judging, by the mobile terminal, whether the click event for the application is detected through the touch screen, and starting the application based on the resources of the application in the memory if the click event for the application is detected through the touch screen; otherwise, executing S304.

S304: acquiring, by the mobile terminal, the distance between the finger and the touch screen through the touch screen at intervals of a preset period of time, judging whether the distance is larger than the second preset value, and releasing the resources of the application in the memory if the distance is larger than the second preset value; otherwise, reserving the resources of the application in the memory.

Based on the same idea, provided in some embodiments of this disclosure is a device for starting an application, which is applied to mobile terminals installed with a touch screen having a floating touch function. For the implementation of the device, reference may be made to the description in the method embodiment section, with repeated description being omitted here. As shown in FIG. 4, the device includes:

a detecting module 401 configured to detect a floating touch event for an application through a touch screen;

a loading module 402 configured to load resources of the application saved in a storage into a memory upon detection of the floating touch event for the application by the detecting module 401; and

a processing module 403 configured to start the application based on the resources of the application loaded into the memory when a click event for the application is detected through the touch screen; otherwise, release the resources of the application in the memory.

In some implementations, the detecting module 401 is configured to :

acquire a distance, detected by the touch screen, between a finger pointing at the application and the touch screen; and

determine the detection of the floating touch event for the application when it is determined that the detected distance is smaller than a first preset value.

In some implementations, the processing module 403 is configured to:

release the resources of the application in the memory when the distance between the finger pointing at the application and the touch screen, which is detected through the touch screen at intervals of a second preset period of time, is larger than a second preset value.

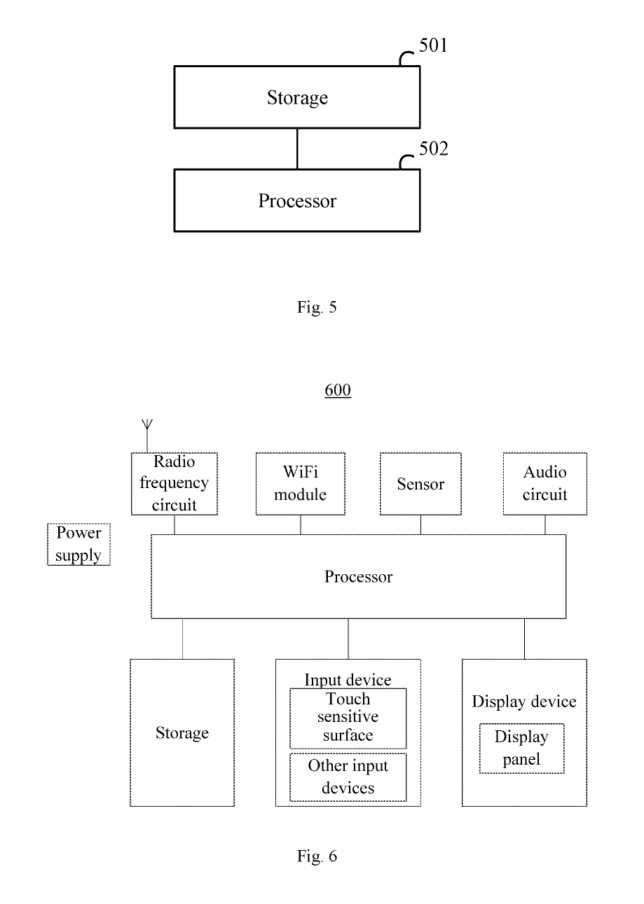

Based on the same idea, also provided in this disclosure is a device for starting an application. For the implementation of the device, reference may be made to the description in the method embodiment section, with repeated description being omitted here. As shown in FIG. 5, the device includes: a storage 501 and one or more processors 502, where, the storage 501 stores one or more computer-readable program codes, and the one or more processors 502 are used for executing the one or more computer-readable program codes to:

detect a floating touch event for an application through a touch screen having a floating touch function;

load resources of the application saved in the storage into a memory upon detection of the floating touch event for the application; and

start the application based on the resources of the application loaded into the memory if a click event for the application is detected through the detecting module; otherwise, release the resources of the application in the memory.

In some implementations, the one or more processors 502 are further used for executing the one or more computer-readable program codes to:

acquire a distance, detected by the touch screen, between a finger pointing at the application and the touch screen; and

determine the detection of the floating touch event for the application if it is determined that the detected distance is smaller than a first preset value.

In some implementations, the one or more processors 502 are further used for executing the one or more computer-readable program codes to:

release the resources of the application in the memory if the click event for the application is not detected through the touch screen within a first period of time.

In some implementations, the one or more processors 502 are further used for executing the one or more computer-readable program codes to:

detect the distance between the finger pointing at the application and the touch screen through the touch screen at intervals of a second preset period of time, and release the resources of the application in the memory when it is determined that the detected distance is larger than a second preset value.

Based on the same idea, as shown in FIG. 6, also provided in some embodiments of this disclosure is a mobile terminal 600. The mobile terminal 600 includes the device as shown in FIG. 4.

The mobile terminal 600 may be a wide variety of handhold devices (e.g. a mobile phone, a tablet, a PDA, etc.), and may include such components as a processor with one or more than one processing cores, a radio frequency circuit, a storage including one or more of computer-readable storage media, an input device, a display device, a sensor, an audio circuit, a WiFi module and a power supply. It may be appreciated by those skilled in the art that the structure of the mobile terminal 600 in this embodiment does not constitute limitations and may include more or less components, or combinations of some components, or different component arrangements. Among these components:

The radio frequency circuit may be used for reception and transmission of signals during the process of information transmission and reception or calling. In particular, after receiving downlink information from a base station, the radio frequency circuit delivers the downlink information to one or more than one processors for processing purposes; in addition, the radio frequency circuit sends to the base station data involving uplink. The radio frequency circuit typically includes, but not limited to an antenna, at least one amplifier, a tuner, one or more oscillators, a subscriber identity module (SIM), a transceiver, a coupler, an LNA (Low Noise Amplifier), a duplexer, etc. Furthermore, the radio frequency circuit may also communicate with other devices by means of wireless communications and networks. The wireless communications may use any of communication standards or protocols including, but not limited to GSM (Global System of Mobile communication), GPRS (General Packet Radio Service), CDMA, (Code Division Multiple Access), WCDMA (Wideband Code Division Multiple Access), LTE (Long Term Evolution), E-Mail, SMS (Short Messaging Service), etc.

The storage may be used to store software programs and modules, and the processor executes various functional applications and data processing by running the software programs and modules stored in the storage. The storage may mainly include a storage program area and a storage data area, where, the storage program area may store operating system, applications required for at least one function (such as sound playback function, image playback function, etc.) and the like; the storage data area may store data (such as audio data, phone book, etc.) created depending on the use of the mobile terminal 600, and the like. In addition, the storage may include a high speed random access memory, and may also include a nonvolatile memory, e.g. at least one disk memory device, flash memory device, or other volatile solid-state memory devices. Accordingly, the storage may also include a storage controller to provide access of the processor and the input device to the storage.

The input device may be used to receive input numbers or character information, and to generate keyboard, mouse, joystick, optic or trackball signal inputs related to user settings and functional control. The input device may include a touch sensitive surface and other input devices, The touch sensitive surface, also referred to as touch display screen or touch panel, is capable of collecting touch operations of a user on or near the touch sensitive surface (for example, the user uses any suitable object or accessory, such as finger or touch pen, for operations on or near the touch sensitive surface), and driving a corresponding connection means according to preset programs. Alternatively, the touch sensitive surface may include two parts, i.e. a touch detection device and a touch controller, where, the touch detecting device detects the orientation of touch by the user and signals derived from touch operations, and transmits the signals to the touch controller; the touch controller receives, from the touch detection device, and converts touch information into touch spot coordinates and then sends the touch spot coordinates to the processor, and the touch controller is capable of receiving commands sent from the processor and executing these commands. Moreover, the touch sensitive surface may be realized in various ways, including resistive type, capacitive type, infrared ray, surface acoustic wave and the like. In addition to the touch sensitive surface, the input device may also include other input devices. The other input devices may include, but not limited to one or more of the group consisting of physical keyboard, functional key (such as volume control key, on/off key, etc.), trackball, mouse, joystick and the like.

The display device may be used to display information input by a user or provided to the user as well as various graphic user interfaces of the mobile terminal 600. These graphic user interfaces may be composed of graphics, texts, icons, videos and any combination thereof. The display device may include a display panel. Alternatively, LCD (Liquid Crystal Display), OLED (Organic Light-Emitting Diode) and other such forms may be employed to configure the display panel. Further, the touch sensitive surface may cover the display panel. After the touch sensitive surface detects a touch operation thereon or nearby, the touch operation is transmitted to the processor to determine the type of the touch event. After that, the processor provides a corresponding visual output on the display panel according to the type of the touch event. While the touch sensitive surface and the display panel serve as two separate components to realize input and output functions in this embodiment, the touch sensitive surface may be integrated with the display panel to realize input and output functions in some embodiments.

The mobile terminal 600 may also include at least one sensor, such as light sensors, motion sensors and other sensors. The light sensors may include an ambient light sensor and a proximity sensor, where the ambient light sensor is capable of adjusting the luminance of the display panel according to the magnitude of ambient light, and the proximity sensor is capable of turning off the display panel and/or backlight when the mobile terminal 600 moves to be next to ears. As one of the motion sensors, a gravity acceleration sensor can detect the magnitudes of accelerations in all directions (normally tri-axis), and the magnitude and direction of gravity while remaining stationary, and can be used for mobile phone gesture recognition applications (such as switching between horizontal and vertical screens, related games, magnetometer gesture calibration), vibration recognition-related functions (such as pedometer, tapping), etc. As for other sensors that may also be configured for the mobile terminal 600, such as gyroscope, barometer, hygrometer, thermometer and infrared sensor, repeated description is omitted here.

An audio circuit, a loudspeaker and a microphone can provide an audio interface between the user and the mobile terminal 600. The audio circuit may transmit electrical signals, converted from the received audio data, to the loudspeaker, which in turns converts the electrical signals to acoustic signal outputs. On the other hand, the microphone converts the collected acoustic signals into electrical signals that are received by the audio circuit and then converted into audio data, and the audio data is output to the processor for being processed and then sent to for example another device via the radio frequency circuit, or the audio data is output to the storage for further processing. Also, it is possible for the audio circuit to include an earplug jack to enable communication between an external earphone and the mobile terminal 600.

WiFi falls under the category of short-range wireless transmission technologies. By way of a WiFi module, the mobile terminal 600 may help users send and receive E-mails, browse webpage and gain access to streaming media, etc. The WiFi module provides users with wireless access to broadband Internet. Although the WiFi module is given in this embodiment, it may be appreciated that the WiFi module does not belong to the necessary composition of the mobile terminal 600, and thus can be completely omitted as required, without varying inventive nature.

As a control part of the mobile terminal 600, the processor utilizes a variety of interfaces and lines for connections with various parts, and executes a variety of functions of the mobile terminal 600 and data processing by running or executing software programs and/or modules stored within the storage and by calling data stored within the storage, so that overall monitoring for the mobile phone is accomplished. Alternatively, the processor may include one or more processing cores. The processor may be integrated with an application processor and a modem processor, where, the application processor functions mainly to process operating system, user interfaces, applications and the like, while the modem processor functions mainly to process wireless communications. It may be appreciated that the abovementioned modem processor may not be integrated into the processor.

The mobile terminal 600 further includes a power supply (such as battery) powering various components. The power supply may be logically connected with the processor via a power management system, so that such functions as charging and discharging under management and power consumption management can be realized through the power management system. The power supply may also include any assembly like one or more than one DC or AC power supplies, rechargeable system, power failure detection circuit, power adapter or inverter, power status indicator, etc.

The mobile terminal 600, though not shown, may also include a camera, a Bluetooth module and the like, and repeated description is omitted here. In this embodiment, the display device of the mobile terminal 600 is a touch screen display, and the mobile terminal also includes a storage and one or more than one programs, where, the one or more than one programs are stored in the memory and configured to be executed by one or more than one processors.

Based on the technical solution stated hereinabove, in some embodiments of this disclosure, the mobile terminal, after detecting a floating touch event for an application through a touch screen having a floating touch function, loads the stored resources of the application into a memory; the application may be started based directly on the resources of the application in the memory after it is determined that an click event for the application is detected through the touch screen, thereby avoiding the consumption of time resources due to loading of the resources of the application into the memory subsequent to the occurrence of the click event, shortening the duration from the occurrence of the click event to running of the application, and optimizing the speed of starting the application.

It should be recognized by those skilled in this art that the embodiments of this disclosure may be provided as a method, system or computer program product. Therefore, this disclosure may take the form of complete hardware embodiments, complete software embodiments, or software/hardware-combined embodiments. Moreover, this disclosure may take the form of a computer program product that is implemented on one or more computer-usable storage media (including, but not limited to disk storage, optical storage and the like) with computer-usable program codes contained therein.

This disclosure is described with reference to the flow diagram and/or block diagram of the method, device (system) and computer program product according to the embodiments of this disclosure. It should be appreciated that each flow and/or block in the flow diagram and/or block diagram, and the combination of the flows and/or blocks in the flow diagram and/or block diagram may be realized by computer program instructions. These computer program instructions may be provided to processors of a general-purpose computer, a special purpose computer, an embedded processor or other programmable data processing devices to generate a machine, such that the instructions executed by the processors of the computers or other programmable data processing devices generate a device for realizing the functions specified in one or more flows of the flow diagram and/or in one or more blocks of the block diagram.

These computer program instructions may also be stored in a computer-readable storage which is capable of guiding the computers or other programmable data processing devices to work in a particular manner, thereby enabling the instructions stored in the computer-readable storage to generate an article of manufacture including an instruction device for realizing the functions specified in one or more flows of the flow diagram and/or in one or more blocks of the block diagram.

These computer program instructions may also be loaded onto the computers or other programmable data processing devices to execute a series of operational steps thereon to generate processing realized by the computers, so that the instructions executed by the computers or other programmable data processing devices provide the steps for realizing the functions specified in one or more flows of the flow diagram and/or in one or more blocks of the block diagram.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A device for starting an application, comprising:
a detecting module configured to detect a floating touch event for an application through a touch screen;
a loading module configured to load resources of the application saved in a storage into a memory upon detection of the floating touch event by the detecting module; and
a processing module configured to start the application based on the resources of the application loaded into the memory when a click event for the application is detected through the touch screen; otherwise, release the resources of the application in the memory.

2. The device of claim 1, wherein the detecting module is further configured to:
acquire a distance, detected by the touch screen, between a finger pointing at the application and the touch screen; and
determine the detection of the floating touch event for the application when the detected distance is smaller than a first preset value.

3. The device of claim 1, wherein the processing module is further configured to:
release the resources of the application in the memory when the click event for the application is not detected through the touch screen within a first preset period of time.

4. The device of claim 2, wherein the processing module is further configured to:
release the resources of the application in the memory when the click event for the application is not detected through the touch screen within a first preset period of time.

5. The device of claim 1, wherein processing module is further configured to:
release the resources of the application in the memory when the distance between the finger pointing at the application and the touch screen, which is detected by the detecting module through the touch screen at intervals of a second preset period of time, is larger than a second preset value.

6. The device of claim 2, wherein the processing module is configured to:
release the resources of the application in the memory when the distance between the finger pointing at the application and the touch screen, which is detected by the detecting module through the touch screen at intervals of a second preset period of time, is larger than a second preset value.

7. A device for starting an application, comprising a storage and one or more processors, wherein the storage stores one or more computer-readable program codes, and the one or more processors are used for executing the one or more computer-readable program codes to:
detect a floating touch event for an application through a touch screen;
load resources of the application saved in the storage into a memory upon detection of the floating touch event by the detecting module; and
start the application based on the resources of the application loaded into the memory when a click event for the application is detected by the detecting module; otherwise, release the resources of the application in the memory.

8. The device of claim 7, wherein the one or more processors are further used for executing the one or more computer-readable program codes to:
acquire a distance, detected by the touch screen, between a finger pointing at the application and the touch screen; and
determine the detection of the floating touch event for the application when the detected distance is smaller than a first preset value.

9. The device of claim 7, wherein the one or more processors are further used for executing the one or more computer-readable program codes to:
release the resources of the application in the memory when the click event for the application is not detected through the touch screen within a first preset period of time.

10. The device of claim 8, wherein the one or more processors are further used for executing the one or more computer-readable program codes to:
release the resources of the application in the memory when the click event for the application is not detected through the touch screen within a first preset period of time.

11. The device of claim 7, wherein the one or more processors are further used for executing the one or more computer-readable program codes to:
release the resources of the application in the memory when the distance between the finger pointing at the application and the touch screen, which is detected by the detecting module through the touch screen at intervals of a second preset period of time, is larger than a second preset value.

12. The device of claim 8, wherein the one or more processors are further used for executing the one or more computer-readable program codes to:
release the resources of the application in the memory when the distance between the finger pointing at the application and the touch screen, which is detected by the detecting module through the touch screen at intervals of a second preset period of time, is larger than a second preset value.

13. A method for starting a mobile terminal application, comprising:
detecting a floating touch event for an application through a touch screen;
loading resources of the application saved in a storage into a memory upon detection of the floating touch event for the application; and
starting the application based on the resources of the application loaded into the memory when a click event for the application is detected through the touch screen; otherwise, releasing the resources of the application in the memory.

14. The method of claim 13, wherein detecting a floating touch event for an application through a touch screen comprises:
acquiring a distance, detected by the touch screen, between a finger pointing at the application and the touch screen; and
determining the detection of the floating touch event for the application when it is determined that the detected distance is smaller than a first preset value.

15. The method of claim 13, wherein releasing the resources of the application in the memory comprises:
releasing the resources of the application in the memory when the click event for the application is not detected through the touch screen within a first preset period of time.

16. The method of claim 14, wherein releasing the resources of the application in the memory comprises:
releasing the resources of the application in the memory when the click event for the application is not detected through the touch screen within a first preset period of time.

17. The method of claim 13, wherein releasing the resources of the application in the memory comprises:
detecting the distance between the finger pointing at the application and the touch screen through the touch screen at intervals of a second preset period of time, and releasing the resources of the application in the memory when it is determined that the detected distance is larger than a second preset value.

18. The method of claim 14, wherein releasing the resources of the application in the memory comprises:
detecting the distance between the finger pointing at the application and the touch screen through the touch screen at intervals of a second preset period of time, and releasing the resources of the application in the memory when it is determined that the detected distance is larger than a second preset value.
